(19) United States
(12) Patent Application Publication
(10) Pub. No.: US 2019/0366567 A1
(43) Pub. Date: Dec. 5, 2019

(54) ADJUSTABLE POCKET CLIP FOR FOLDING KNIVES

(71) Applicant: Jeffrey Todd Mitchell, Sanford, FL (US)

(72) Inventor: Jeffrey Todd Mitchell, Sanford, FL (US)

(21) Appl. No.: 16/430,212

(22) Filed: Jun. 3, 2019

Related U.S. Application Data
(60) Provisional application No. 62/763,070, filed on Jun. 4, 2018.

(51) Int. Cl. B26B 1/10; B26B 1/02

(52) U.S. Cl. CPC B26B 1/10; F16M 13/04; B26B 1/02

(57) ABSTRACT

A pocket clip device includes first and second handle sections having a plurality of mounting apertures that align with the threaded receivers of a knife body. A pocket clip having an elongated body section is selectively secured along the length of either handle section at any orientation. Each handle section has an elongated channel along an inside facing surface and a square nut is slidingly positioned along the channel. At least one elongated slot is provided in each of the channels for receiving a pair of retaining screws which secure the clip to the respective handle. The device also includes a folding knife having a main body, a blade, and a blade folding mechanism that is secured to the first and second handle sections.

### CROSS-REFERENCE TO RELATED APPLICATIONS

This application claims the benefit of U.S. Application Ser. No. 62/763,070 filed on Jun. 4, 2018, the contents of which are incorporated herein by reference.

### TECHNICAL FIELD

The present invention relates generally to folding knives, and more particularly to a pocket clip having an adjustable location and orientation along the knife.

### BACKGROUND

The statements in this section merely provide background information related to the present disclosure and may not constitute prior art.

Knives with foldable blades were first produced over one thousand years ago. Modern “folding” knives have been in use for hundreds of years. Today, folding knives of all types are more common than ever before.

Most folding knives are intended to be carried in a front pants pocket instead of a pouch or a sheath. Therefore, many of these “pocket” knives are now equipped with a “pocket clip” which can be slipped over the edge of the pocket. This clip holds the knife stationary within the pocket and allows the knife to be drawn from the pocket quickly and easily.

The pocket clip on a contemporary folding knife is often created from a simple stamping of stainless steel or titanium, and the clip is usually attached to the knife with small screws. Typically, the folding knife has two sets of threaded holes within each handle. These holes allow the pocket clip to be attached to one of four fixed positions on the knife. These four locations enable the knife to be carried tip-up or tip-down in either the right-hand or left-hand pocket.

A small folding knife with a pocket clip can be comfortably and securely carried in any pocket, even a front pocket. However, it is much more difficult to carry a large folding knife in the front pocket of pants or shorts. Naturally, a large pocketknife extends deeper into the front pocket than a small pocketknife. Just sitting down with a large folding knife in a front pocket can be problematic. It may not only be uncomfortable, but the knife could become dislodged or even lost.

A “deep carry” pocket clip is available to allow a folding knife to be completely concealed when carried in a pocket. This clip simply replaces the existing pocket clip and attaches to the folding knife in the same manner as the original pocket clip. A deep carry pocket clip can be very useful and effective on a small pocketknife. However, a deep carry pocket clip makes it even more difficult to comfortably carry a large folding knife in a pocket.

Accordingly, it would be beneficial to provide an adjustable pocket clip for folding knives that can allow a user to quickly and easily adjust the location and/or orientation of the clip longitudinally along the folding knife body to overcome the deficiencies described above.

### SUMMARY OF THE INVENTION

The present invention comprises an adjustable pocket clip device for attachment to a folding knife. One embodiment of the present invention can include first and second handle sections having a plurality of mounting apertures that align with the threaded receivers of a knife body. The device can include a pocket clip having an elongated body section that is selectively secured anywhere along the length of each handle section at any orientation.

Another embodiment of the present invention can include each handle section having an elongated channel along an inside facing surface with each channel housing one or more square nuts that are slidingly positioned along the channel. At least one elongated slot can be provided in each of the channels for receiving one or more retaining screws which secure the clip to the respective handle.

Another embodiment of the present invention comprises a folding knife having a main body, a blade, and a blade folding mechanism. First and second handle sections can be removably secured to the main body and a pocket clip having an elongated body section can be selectively secured anywhere along the length of each handle section at any orientation.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of a folding knife with an adjustable pocket clip that is useful for understanding the inventive concepts disclosed herein.

FIG. 2 is a partially exploded view of the adjustable pocket clip device, in accordance with one embodiment of the invention.

FIG. 3 is a perspective view of the adjustable pocket clip device in operation, in accordance with one embodiment of the invention.

FIG. 4 is another perspective view of the adjustable pocket clip device in operation, in accordance with one embodiment of the invention.

FIG. 5 is another perspective view of the adjustable pocket clip device in operation, in accordance with one embodiment of the invention.

FIG. 6 is another perspective view of the adjustable pocket clip device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the terms “connector” and “complementary connector” include any number of different elements that work together to repeatedly join two items together in a nonpermanent manner. Several nonlimiting examples include opposing strips of hook and loop material (i.e. Velcro®), attractively oriented magnetic elements, and compression fittings such as draw latches, hooks, snaps, buttons, and nut/bolt combinations, for example.

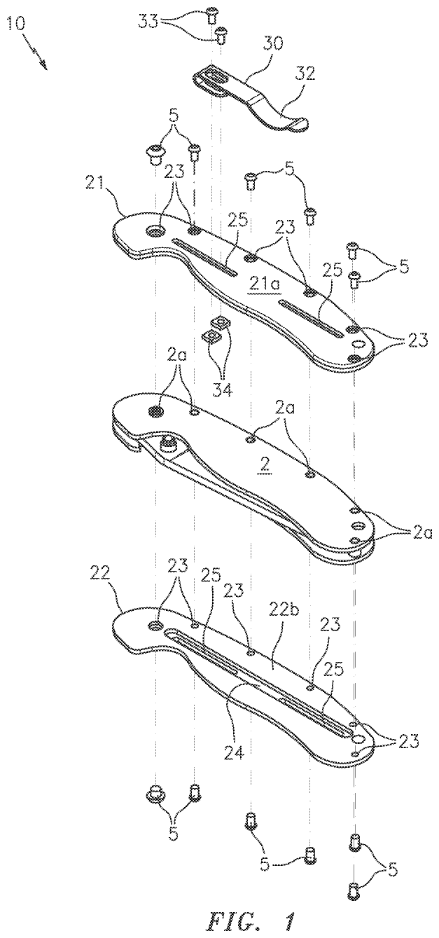

FIGS. 1-6 illustrate one embodiment of an adjustable pocket clip device for folding knives that is useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

As shown in the drawings, the device 10 can include, essentially, a pair of knife handles 21 and 22, for receiving a removable and adjustable clip 30. The clip can be secured to each of the handle sections (separately) and can be secured at any position along the length of each handle and at any orientation. As defined herein, the orientation of the clip refers to rotational positioning e.g., wherein the major axis of the clip can rotate 360 degrees relative to the major axis of the handle body.

In various embodiments, the device 10 can be constructed as a complete folding knife wherein the device is factory mounted to a knife body 2 having a blade and folding mechanism as described above. Additionally, embodiments are contemplated wherein the device 10 is constructed for use with existing knife bodies 2 or those made by other manufacturers, so as to implement the inventive concepts thereto. In this regard, the handles of an existing knife can be removed and the device 10 can be mounted to the knife body in the same manner described herein.

In either instance, each of the handle sections 21 and 22 can include elongated members having an outside facing surface 21a/22a, and an inside facing surface 21b/22b, respectively. Each handle section 21 and 22 can include a shape and size that is complementary to the shape and size of the left or right side of the main body 2, to which the handle is to be mated so as to form the left hand grip and the right hand grip, respectively.

Each of the handle sections can include any number of different markings and/or texturing along the outside surface and can be constructed from any number of different materials that are, for example, relatively strong and stiff for their weight. Several nonlimiting examples include, but are not limited to various metals or metal alloys (e.g., aluminum, steel, titanium, or alloys thereof), plastic/polymers (e.g., high-density polyethylene (HDPE), rigid polyvinyl chloride (PVC), or polyethylene terephthalate (PET)), various composite materials (e.g., carbon fibers in a polymer matrix, fiberglass, etc.), and/or various natural materials such as wood, for example.

In one embodiment, each handle section 21 and 22 can include a plurality of apertures 23 that are aligned with the threaded receivers 2a of the main body to receive screws 5 that secure the handle sections to the main body.

In one embodiment, the inside facing surface 21b and 22b of each handle section can include an elongated channel 24 forming an indentation that extends longitudinally along the major axis of the respective handle section. The channel 24 of each handle section includes at least one (and preferably two) elongated slots 25 passing through to the outside facing surface 21a and 22a, respectively.

In one embodiment, the clip 30 can include an elongated body section having two openings 31 along the top end and a bent middle portion 32 for maintaining contact between the bottom end of the clip and the handle section to which it is secured. The clip body can be constructed from any number of different materials, preferably metal, and can include any number of different shapes and sizes.

As shown best at FIG. 2, the clip 30 is designed to be removably secured to either handle section 21 or 22 in any number of different orientations and locations. In the preferred embodiment, the clip can be secured to a respective handle section by first passing a pair of retaining screws 33 through the openings 31 and the elongated slot 25 of the desired handle. Next, the distal ends of the retaining screws can engage a pair of square nuts 34 that are located within the elongated channel 24. As is known to those of skill in the art, the square nuts are sized to be complementary to the width of the channel so as to permit movement longitudinally but prevent movement rotationally. Next, the user can slide the clip along the handle to the desired location before tightening the screw to prevent further movement.

Although described above as using a connector in the form of retaining screws 33 and square nuts 34, this is for illustrative purposes only. To this end, those of skill in the art will recognize that any number and/or types of other connectors that are capable of securing the clip 30 to the handle section(s) in a removable and adjustable manner are also contemplated. Accordingly, the inventive concepts are not to be construed as limiting to the particular mounting hardware illustrated.

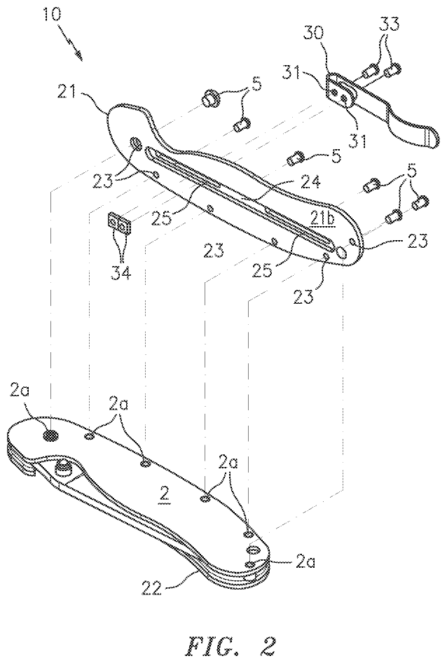

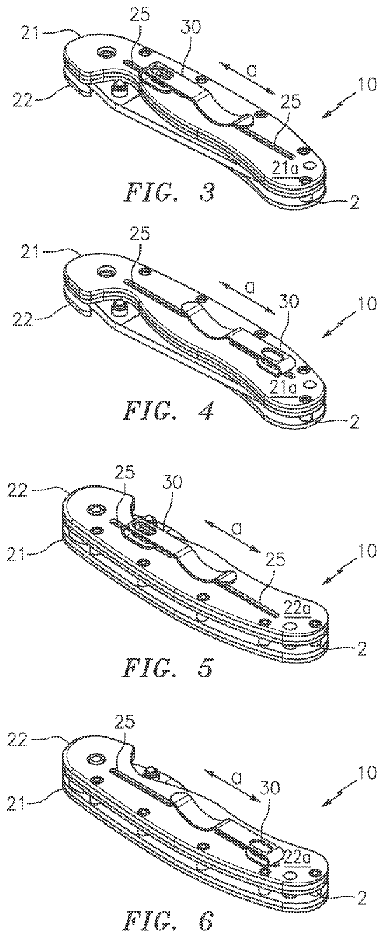

As shown at FIGS. 3-6, when the handle sections 21 and 22 are secured to the main body 2, the clip 30 can be positioned at any location along the entire length of the assembled knife (see arrow a) at any orientation, so as to allow a user to adjust the location and orientation of the knife when it is secured to a pocket or other article.

For example, when positioned as shown at FIG. 3, this configuration allows the user to carry his knife tip-down in his left pocket. When positioned as shown at FIG. 4, the knife has been configured for tip-up, left-hand carry. This can be done by simply removing the pocket clip screws 33. Tipping the knife up will allow the square nuts 34 to slide within the longitudinal channel 24 until they are positioned behind the adjacent slot 25. At this time, the clip body can be rotated 180 degrees and re-secured to the square nuts as described above.

As show at FIGS. 5 and 6, the steps and procedures outlined at FIGS. 3 and 4 can be repeated on handle section 22 to achieve the same results for righthanded carry in exactly the same manner as described above.

Accordingly, the above described adjustable pocket clip for folding knives provides a new and innovative solution for users that can be embodied in the design of a new knife or incorporated into an existing knife that is not rendered obvious by the known art.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the terms “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. An adjustable pocket clip device for a folding knife, said device comprising:
a first handle section having an inside facing surface, an outside facing surface, and a first plurality of mounting apertures;
a second handle section having an inside facing surface, an outside facing surface, and a second plurality of mounting apertures; and
a pocket clip having an elongated body section that is configured to be removably secured to each of the first handle section and the second handle section separately,
wherein the first handle section and the second handle section are each configured to be removably secured to a folding knife body.

2. The device of claim 1, further comprising:
a plurality of connectors that are interposed between the pocket clip and one of the first handle section and the second handle section.

3. The device of claim 2, wherein the plurality of connectors includes functionality for selectively positioning the pocket clip at any location along a length of each of the first handle section and the second handle section.

4. The device of claim 3, wherein the plurality of connectors includes functionality for selectively positioning the pocket clip at any orientation along each of the first handle section and the second handle section.

5. The device of claim 1, further comprising:
a first elongated channel that is disposed longitudinally along the inside facing surface of the first handle section; and
a second elongated channel that is disposed longitudinally along the inside facing surface of the second handle section.

6. The device of claim 5, further comprising;
at least one elongated slot that is positioned along the first elongated channel; and
at least one elongated slot that is positioned along the second elongated channel.

7. The device of claim 6, further comprising:
a plurality of retaining nuts that are positioned within each of the elongated channels, and
wherein the pocket clip is removably connected to the first or second handle by at least one retaining screw that is fastened to one of the plurality of retaining nuts.

8. The device of claim 7, wherein the pocket clip is selectively positionable at any location along a length of each of the first handle section and the second handle section.

9. The device of claim 7, wherein the pocket clip is selectively positionable at any orientation along each of the first handle section and the second handle section.

10. The device of claim 1, wherein each of the first plurality of apertures and the second plurality of apertures align with a plurality of threaded receivers located along the folding knife body.

11. A folding knife with an adjustable pocket clip device, said device comprising:
a main body having a first side, a second side, a blade and a blade folding mechanism;
a first handle section having an inside facing surface that is removably engaged to the first side of the main body;
a second handle section having an inside facing surface that is removably engaged to the second side of the main body; and
a pocket clip having an elongated body section that is configured to be removably secured to each of the first handle section and the second handle section separately.

12. The device of claim 10, further comprising:
a plurality of connectors that are interposed between the pocket clip and one of the first handle section and the second handle section.

13. The device of claim 12, wherein the plurality of connectors includes functionality for selectively positioning the pocket clip at any location along a length of each of the first handle section and the second handle section.

14. The device of claim 13, wherein the plurality of connectors includes functionality for selectively positioning the pocket clip at any orientation along each of the first handle section and the second handle section.

15. The device of claim 10, further comprising:
a first elongated channel that is disposed longitudinally along the inside facing surface of the first handle section; and
a second elongated channel that is disposed longitudinally along the inside facing surface of the second handle section.

16. The device of claim 15, further comprising;
at least one elongated slot that is positioned along the first elongated channel; and
at least one elongated slot that is positioned along the second elongated channel.

17. The device of claim 16, further comprising:
a plurality of retaining nuts that are positioned within each of the elongated channels, and
wherein the pocket clip is removably connected to the first or second handle by at least one retaining screw that is fastened to one of the plurality of retaining nuts.

18. The device of claim 17, wherein the pocket clip is selectively positionable at any location along a length of each of the first handle section and the second handle section.

19. The device of claim 17, wherein the pocket clip is selectively positionable at any orientation along each of the first handle section and the second handle section.

20. The device of claim 1, further comprising:
a plurality of apertures that are located along each of the first handle section and the second handle section; and
a plurality of threaded receivers that are located along each of the first side and the second side of the main body,
wherein the plurality of apertures aligns with the plurality of threaded receivers and are each configured to receive a screw for securing the first handle section and the second handle section to the main body.
